(19) United States
(12) Patent Application Publication
(10) Pub. No.: US 2015/0355585 A1
(43) Pub. Date: Dec. 10, 2015

(54) FIXING DEVICE AND IMAGE FORMING APPARATUS

(71) Applicants: Akira SUZUKI, Tokyo (JP); Takuya SESHITA, Kanagawa (JP); Takeshi YAMAMOTO, Kanagawa (JP); Takahiro IMADA, Kanagawa (JP); Hajime GOTOH, Kanagawa (JP)

(72) Inventors: Akira SUZUKI, Tokyo (JP); Takuya SESHITA, Kanagawa (JP); Takeshi YAMAMOTO, Kanagawa (JP); Takahiro IMADA, Kanagawa (JP); Hajime GOTOH, Kanagawa (JP)

(73) Assignee: RICOH COMPANY, LTD., Tokyo (JP)

(21) Appl. No.: 14/723,913

(22) Filed: May 28, 2015

(30) Foreign Application Priority Data
Jun. 10, 2014 (JP) 2014-119450

(51) Int. Cl. G03G 15/20

(52) U.S. Cl. CPC G03G 15/2053

(57) ABSTRACT

A fixing device includes an endless fixing belt rotatable in a given direction of rotation and a first nip formation pad contacting an inner circumferential surface of the fixing belt. A first driver sandwiches the fixing belt together with the first nip formation pad to rotate to drive and rotate the fixing belt. An opposed rotator is pressed against the first nip formation pad via the fixing belt to form a fixing nip between the fixing belt and the opposed rotator, through which a recording medium is conveyed. The opposed rotator is rotated frictionally by the fixing belt at the fixing nip.

### CROSS-REFERENCE TO RELATED APPLICATION

This patent application is based on and claims priority pursuant to 35 U.S.C. §119 to Japanese Patent Application No. 2014-119450, filed on Jun. 10, 2014, in the Japanese Patent Office, the entire disclosure of which is hereby incorporated by reference herein.

### BACKGROUND

1. Technical Field

Example embodiments generally relate to a fixing device and an image forming apparatus, and more particularly, to a fixing device for fixing a toner image on a recording medium and an image forming apparatus incorporating the fixing device.

2. Background Art

Related-art image forming apparatuses, such as copiers, facsimile machines, printers, or multifunction printers having two or more of copying, printing, scanning, facsimile, plotter, and other functions, typically form an image on a recording medium according to image data. Thus, for example, a charger uniformly charges a surface of a photoconductor; an optical writer emits a light beam onto the charged surface of the photoconductor to form an electrostatic latent image on the photoconductor according to the image data; a developing device supplies toner to the electrostatic latent image formed on the photoconductor to render the electrostatic latent image visible as a toner image; the toner image is directly transferred from the photoconductor onto a recording medium or is indirectly transferred from the photoconductor onto a recording medium via an intermediate transfer belt; finally, a fixing device applies heat and pressure to the recording medium bearing the toner image to fix the toner image on the recording medium, thus forming the image on the recording medium.

Such fixing device may include a first rotator, such as a fixing roller, a fixing belt, and a fixing film, heated by a heater and a second rotator, such as a pressure roller and a pressure belt, pressed against the first rotator to form a fixing nip therebetween through which a recording medium bearing a toner image is conveyed. As the recording medium bearing the toner image is conveyed through the fixing nip, the first rotator and the second rotator apply heat and pressure to the recording medium, melting and fixing the toner image on the recording medium.

### SUMMARY

At least one embodiment provides a novel fixing device that includes an endless fixing belt rotatable in a given direction of rotation and a first nip formation pad contacting an inner circumferential surface of the fixing belt. A first driver sandwiches the fixing belt together with the first nip formation pad to rotate to drive and rotate the fixing belt. An opposed rotator is pressed against the first nip formation pad via the fixing belt to form a fixing nip between the fixing belt and the opposed rotator, through which a recording medium is conveyed. The opposed rotator is rotated frictionally by the fixing belt at the fixing nip.

At least one embodiment provides a novel image forming apparatus that includes an image forming device to form a toner image and a fixing device, disposed downstream from the image forming device in a recording medium conveyance direction, to fix the toner image on a recording medium. The fixing device includes an endless fixing belt rotatable in a given direction of rotation and a first nip formation pad contacting an inner circumferential surface of the fixing belt. A first driver sandwiches the fixing belt together with the first nip formation pad to rotate to drive and rotate the fixing belt. An opposed rotator is pressed against the first nip formation pad via the fixing belt to form a fixing nip between the fixing belt and the opposed rotator, through which a recording medium is conveyed. The opposed rotator is rotated frictionally by the fixing belt at the fixing nip. Additional features and advantages of example embodiments will be more fully apparent from the following detailed description, the accompanying drawings, and the associated claims.

### BRIEF DESCRIPTION OF THE DRAWINGS

A more complete appreciation of example embodiments and the many attendant advantages thereof will be readily obtained as the same becomes better understood by reference to the following detailed description when considered in connection with the accompanying drawings, wherein:

FIG. 1 is a schematic vertical sectional view of an image forming apparatus according to an example embodiment of the present disclosure;

FIG. 2 is a schematic vertical sectional view of a fixing device at a center thereof according to a first example embodiment of the present disclosure that is incorporated in the image forming apparatus shown in FIG. 1;

FIG. 3 is a schematic vertical sectional view of the fixing device shown in FIG. 2 at a lateral end thereof;

FIG. 4 is a schematic horizontal sectional view of the fixing device shown in FIG. 2 seen from a direction A;

FIG. 5 is a schematic vertical sectional view of a fixing device at a center thereof according to a second example embodiment of the present disclosure;

FIG. 6 is a schematic vertical sectional view of the fixing device shown in FIG. 5 at a lateral end thereof;

FIG. 7 is a schematic horizontal sectional view of the fixing device shown in FIG. 5 seen from the direction A;

FIG. 8 is a partial horizontal sectional view of the fixing device shown in FIG. 7;

FIG. 9 is a partial horizontal sectional view of the fixing device shown in FIG. 8 illustrating a friction resistance layer of a fixing belt incorporated therein; and

FIG. 10 is a partial horizontal sectional view of a fixing device according to a third example embodiment of the present disclosure.

The accompanying drawings are intended to depict example embodiments and should not be interpreted to limit the scope thereof. The accompanying drawings are not to be considered as drawn to scale unless explicitly noted.

### DETAILED DESCRIPTION

It will be understood that if an element or layer is referred to as being “on”, “against”, “connected to”, or “coupled to” another element or layer, then it can be directly on, against, connected or coupled to the other element or layer, or intervening elements or layers may be present. In contrast, if an element is referred to as being “directly on”, “directly connected to”, or “directly coupled to” another element or layer, then there are no intervening elements or layers present. Like numbers refer to like elements throughout. As used herein, the term “and/or” includes any and all combinations of one or more of the associated listed items.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a term such as “below” can encompass both an orientation of above and below. The device may be otherwise oriented (rotated 90 degrees or at other orientations) and the spatially relative descriptors used herein are interpreted accordingly.

Although the terms first, second, and the like may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present disclosure.

The terminology used herein is for the purpose of describing particular embodiments only and is not intended to be limiting of the present disclosure. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this specification is not intended to be limited to the specific terminology so selected and it is to be understood that each specific element includes all technical equivalents that operate in a similar manner.

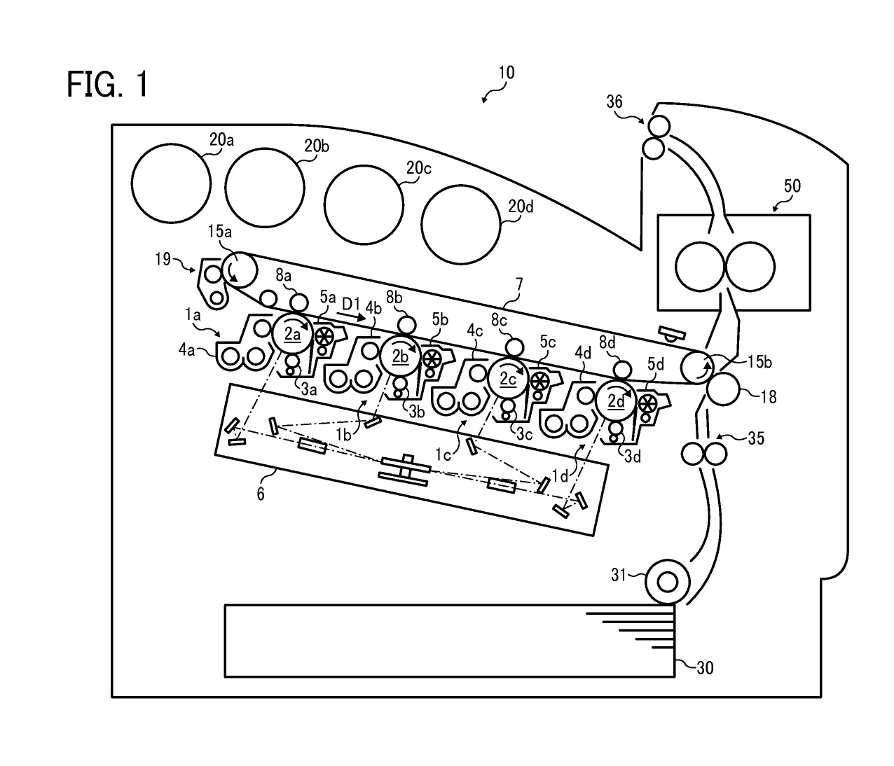

Referring now to the drawings, wherein like reference numerals designate identical or corresponding parts throughout the several views, particularly to FIG. 1, an image forming apparatus 10 according to an example embodiment is explained.

FIG. 1 is a schematic vertical sectional view of the image forming apparatus 10. The image forming apparatus 10 may be a copier, a facsimile machine, a printer, a multifunction peripheral or a multifunction printer (MFP) having at least one of copying, printing, scanning, facsimile, and plotter functions, or the like. According to this example embodiment, the image forming apparatus 10 is a color printer that forms color and monochrome toner images on recording media by electrophotography. Alternatively, the image forming apparatus 10 may be a monochrome printer that forms monochrome toner images.

With reference to FIG. 1, a description is provided of a construction of the image forming apparatus 10.

It is to be noted that, in the drawings for explaining example embodiments of this disclosure, identical reference numerals are assigned as long as discrimination is possible to components such as members and component parts having an identical function or shape, thus omitting description thereof once it is provided.

As shown in FIG. 1, the image forming apparatus 10 includes a plurality of image forming devices, that is, four image forming devices 1a, 1b, 1c, and 1d, that form a toner image on a recording medium by electrophotography. The image forming devices 1a, 1b, 1c, and 1d, although they have an identical structure, use toners different in color. For example, the image forming devices 1a, 1b, 1c, and 1d form black, magenta, cyan, and yellow toner images, respectively.

The image forming devices 1a, 1b, 1c, and 1d include drum-shaped photoconductors 2a, 2b, 2c, and 2d serving as electrostatic latent image bearers surrounded by chargers 3a, 3b, 3c, and 3d, developing devices 4a, 4b, 4c, and 4d, and cleaners 5a, 5b, 5c, and 5d, respectively. Each of the photoconductors 2a, 2b, 2c, and 2d is rotatable clockwise in FIG. 1. The chargers 3a, 3b, 3c, and 3d press against an outer circumferential surface of the respective photoconductors 2a, 2b, 2c, and 2d. The chargers 3a, 3b, 3c, and 3d are driven and rotated in accordance with rotation of the photoconductors 2a, 2b, 2c, and 2d, respectively. A high voltage power supply applies a given bias voltage to the chargers 3a, 3b, 3c, and 3d, thus uniformly charging the outer circumferential surface of the respective photoconductors 2a, 2b, 2c, and 2d rotating clockwise in FIG. 1. Each of the chargers 3a, 3b, 3c, and 3d includes a roller contacting the respective photoconductors 2a, 2b, 2c, and 2d. Alternatively, the chargers 3a, 3b, 3c, and 3d may charge the photoconductors 2a, 2b, 2c, and 2d without contacting the photoconductors 2a, 2b, 2c, and 2d, respectively, by corona discharge or the like.

The image forming apparatus 10 further includes an exposure device 6 being parallel to the four image forming devices 1a, 1b, 1c, and 1d and tilted downward. For example, the exposure device 6 includes a light source, a polygon mirror, an f-O lens, and reflection mirrors. The exposure device 6 exposes the charged outer circumferential surface of the respective photoconductors 2a, 2b, 2c, and 2d with light according to image data sent from an external device such as a client computer, that is, black magenta, cyan, and yellow image data, thus forming electrostatic latent images on the photoconductors 2a, 2b, 2c, and 2d. The developing devices 4a, 4b, 4c, and 4d supply black, magenta, cyan, and yellow toners to the electrostatic latent images formed on the photoconductors 2a, 2b, 2c, and 2d rotating clockwise in FIG. 1, visualizing the electrostatic latent images into black, magenta, cyan, and yellow toner images, respectively. In an upper portion of the image forming apparatus 10 are toner bottles 20a, 20b, 20c, and 20d containing fresh black, magenta, cyan, and yellow toners, respectively. The fresh black, magenta, cyan, and yellow toners in a given amount are supplied from the toner bottles 20a, 20b, 20c, and 20d to the developing devices 4a, 4b, 4c, and 4d through toner supply tubes interposed between the toner bottles 20a, 20b, 20c, and 20d and the developing devices 4a, 4b, 4c, and 4d, respectively.

An endless belt type intermediate transfer belt 7 serving as an intermediate transferor is disposed opposite the photoconductors 2a, 2b, 2c, and 2d that contact an outer circumferential surface of the intermediate transfer belt 7. The intermediate transfer belt 7 is looped over a plurality of support rollers (e.g., support rollers 15a and 15b). The support roller 15a is connected to a driving motor serving as a driver. As the driving motor is actuated, the driving motor drives and rotates the support roller 15a which in turn drives and rotates the intermediate transfer belt 7 counterclockwise in FIG. 1 in a rotation direction D1, rotating the support roller 15b counterclockwise in FIG. 1 in accordance with rotation of the intermediate transfer belt 7. Primary transfer rollers 8a, 8b, 8c, and 8d disposed opposite the photoconductors 2a, 2b, 2c, and 2d via the intermediate transfer belt 7 contact an inner circumferential surface of the intermediate transfer belt 7. The high voltage power supply applies a primary transfer bias to the primary transfer rollers 8a, 8b, 8c, and 8d to primarily transfer the black, magenta, cyan, and yellow toner images formed on the photoconductors 2a, 2b, 2c, and 2d onto the intermediate transfer belt 7. The cleaners 5a, 5b, 5c, and 5d remove residual toners failed to be transferred onto the intermediate transfer belt 7 and therefore remaining on the photoconductors 2a, 2b, 2c, and 2d therefrom, rendering the photoconductors 2a, 2b, 2c, and 2d to be ready for a next image formation.

Downstream from the primary transfer rollers 8a, 8b, 8c, and 8d in the rotation direction D1 of the intermediate transfer belt 7 is a secondary transfer roller 18 serving as a secondary transferor. The secondary transfer roller 18 and the support roller 15b sandwich the intermediate transfer belt 7. The secondary transfer roller 18 is disposed opposite the support roller 15b via the intermediate transfer belt 7 to form a secondary transfer nip between the intermediate transfer belt 7 and the secondary transfer roller 18. The image forming apparatus 10 further includes a paper tray 30 that loads a plurality of recording media, a feed roller 31, and a registration roller pair 35. Downstream from the secondary transfer roller 18 in a recording medium conveyance direction is a fixing device 50 and an output roller pair 36.

A description is provided of an image forming operation performed by the image forming apparatus 10.

Also in the image forming operation, identical image forming processes are performed on the photoconductors 2a, 2b, 2c, and 2d although toner images in different colors are formed on the photoconductors 2a, 2b, 2c, and 2d, respectively.

As the image forming apparatus 10 receives a print job, a driver drives and rotates the photoconductors 2a, 2b, 2c, and 2d clockwise in FIG. 1. Dischargers emit light onto the outer circumferential surface of the respective photoconductors 2a, 2b, 2c, and 2d, initializing a surface potential of the respective photoconductors 2a, 2b, 2c, and 2d. The chargers 3a, 3b, 3c, and 3d uniformly charge the outer circumferential surface of the respective photoconductors 2a, 2b, 2c, and 2d at a given polarity. The exposure device 6 emits laser beams onto the charged outer circumferential surface of the respective photoconductors 2a, 2b, 2c, and 2d according to black, magenta, cyan, and yellow image data constituting color image data sent from the external device, thus forming electrostatic latent images thereon. As the electrostatic latent images formed on the photoconductors 2a, 2b, 2c, and 2d pass through the developing devices 4a, 4b, 4c, and 4d, the developing devices 4a, 4b, 4c, and 4d supply a developer, that is, black, magenta, cyan, and yellow toners, to the electrostatic latent images formed on the photoconductors 2a, 2b, 2c, and 2d, visualizing the electrostatic latent images into black, magenta, cyan, and yellow toner images, respectively.

The intermediate transfer belt 7 is driven and rotated counterclockwise in FIG. 1 in the rotation direction D1. The primary transfer rollers 8a, 8b, 8c, and 8d are applied with a primary transfer voltage having a polarity opposite a polarity of the charged toner of the black, magenta, cyan, and yellow toner images formed on the photoconductors 2a, 2b, 2c, and 2d, creating a transfer electric field at each primary transfer nip formed between the photoconductors 2a, 2b, 2c, and 2d and the intermediate transfer belt 7. The primary transfer rollers 8a, 8b, 8c, and 8d primarily transfer the black, magenta, cyan, and yellow toner images formed on the photoconductors 2a, 2b, 2c, and 2d electrostatically onto the intermediate transfer belt 7 driven and rotated counterclockwise in FIG. 1 in the rotation direction D1 in synchronism with rotation of the photoconductors 2a, 2b, 2c, and 2d. For example, the black, magenta, cyan, and yellow toner images formed on the photoconductors 2a, 2b, 2c, and 2d are primarily transferred from the upstream photoconductor 2a to the downstream photoconductor 2d in the rotation direction D1 of the intermediate transfer belt 7 at different times so that the black, magenta, cyan, and yellow toner images are superimposed on a same position on the intermediate transfer belt 7, thus forming a desired color toner image on the intermediate transfer belt 7.

On the other hand, the feed roller 31 and other conveyance member pick up and separate an uppermost recording medium from other recording media loaded on the paper tray 30 and feed the uppermost recording medium to the registration roller pair 35. As a leading edge of the uppermost recording medium strikes a roller nip formed between two rollers of the registration roller pair 35 before starting rotation, the registration roller pair 35 produces a loop of the recording medium, thus performing registration of the recording medium. Thereafter, the registration roller pair 35 starts rotation at a time corresponding to a time when the color toner image formed on the intermediate transfer belt 7 reaches the secondary transfer nip formed between the intermediate transfer belt 7 and the secondary transfer roller 18. For example, the registration roller pair 35 feeds the recording medium to the secondary transfer nip at the time when the color toner image on the intermediate transfer belt 7 reaches the secondary transfer nip.

According to this example embodiment, the secondary transfer roller 18 is applied with a transfer voltage having a polarity opposite a polarity of toner of the color toner image formed on the intermediate transfer belt 7. Thus, the secondary transfer roller 18 secondarily transfers the color toner image formed on the outer circumferential surface of the intermediate transfer belt 7 onto the recording medium collectively.

The recording medium bearing the color toner image is conveyed to the fixing device 50. As the recording medium bearing the color toner image is conveyed through the fixing device 50, the fixing device 50 fixes the color toner image on the recording medium under heat and pressure. The recording medium bearing the fixed toner image is ejected onto an output portion such as an output tray through the output roller pair 36. After the secondary transfer, an intermediate transfer belt cleaner 19 removes and collects residual toner failed to be transferred onto the recording medium and therefore remaining on the intermediate transfer belt 7 therefrom.

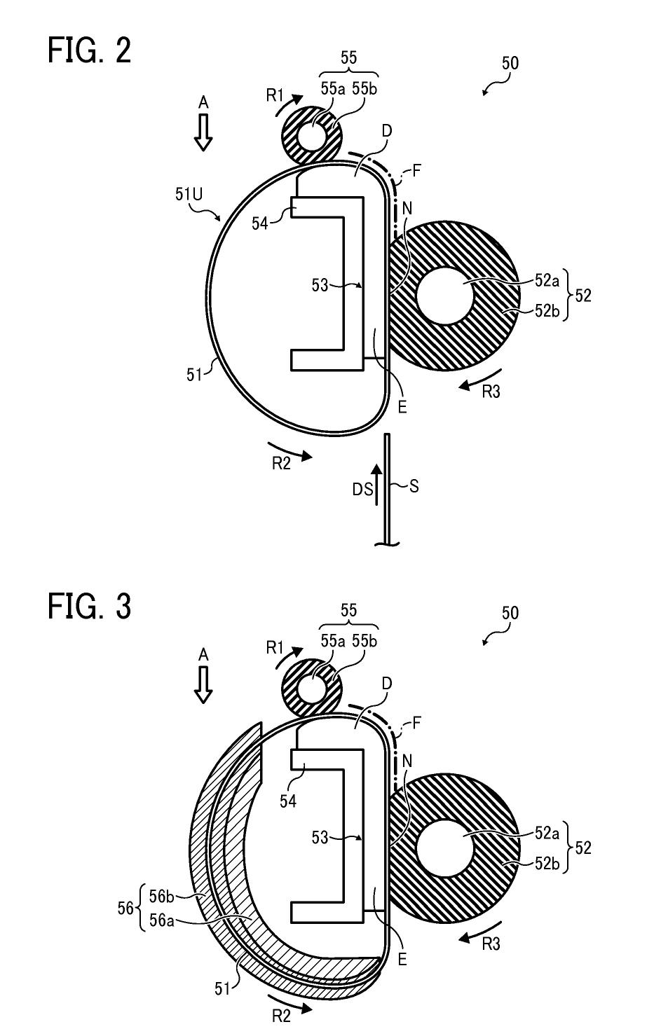

With reference to FIGS. 2 to 4, a description is provided of a construction of the fixing device 50 according to a first example embodiment that is incorporated in the image forming apparatus 10 shown in FIG. 1.

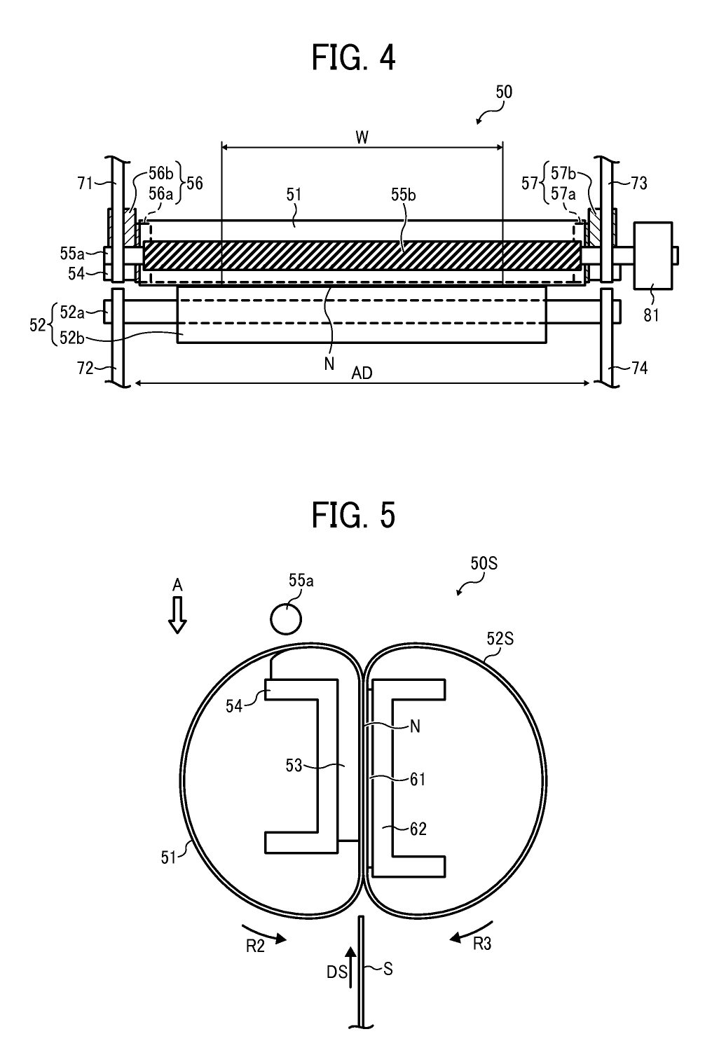

FIG. 2 is a schematic vertical sectional view of the fixing device 50 at a center thereof. FIG. 3 is a schematic vertical sectional view of the fixing device 50 at a lateral end thereof. FIG. 4 is a schematic horizontal sectional view of the fixing device 50 seen from a direction A in FIGS. 2 and 3 as an axial direction AD of a fixing belt 51 defines a horizontal direction.

As shown in FIG. 2, the fixing device 50 (e.g., a fuser or a fusing unit) includes the endless fixing belt 51 serving as an endless belt or a first rotator and a pressure roller 52 serving as an opposed rotator or a second rotator disposed opposite the fixing belt 51. The pressure roller 52 is pressed against the fixing belt 51 such that an outer circumferential surface of the pressure roller 52 contacts an outer circumferential surface of the fixing belt 51, forming a fixing nip N therebetween.

An inner circumferential surface of the fixing belt 51 contacts and slides over a first nip formation pad 53 disposed inside a loop formed by the fixing belt 51 to support the fixing belt 51 to form the fixing nip N. A first support 54 contacts and supports the first nip formation pad 53 to suppress deformation of the first nip formation pad 53 that may appear as the first nip formation pad 53 receives pressure or reaction from the fixing nip N. The fixing belt 51 and the components disposed inside the loop formed by the fixing belt 51, that is, the first nip formation pad 53, the first support 54, and the like, may constitute a belt unit 51U separably coupled with the pressure roller 52.

The pressure roller 52 does not drive and rotate the fixing belt 51. Instead, a driver 55 contacting the outer circumferential surface of the fixing belt 51 drives and rotates the fixing belt 51. As the driver 55 (e.g., a roller) rotates clockwise in FIG. 2 in a rotation direction R1 while the driver 55 and the first nip formation pad 53 sandwich the fixing belt 51, the driver 55 drives and rotates the fixing belt 51 counterclockwise in FIG. 2 in a rotation direction R2. Accordingly, the driver 55 decreases the rotation torque exerted to the pressure roller 52, suppressing damage and breakage of the pressure roller 52, even if the pressure roller 52 is made of an elastic body having a decreased rigidity, and therefore attaining an extended life of the pressure roller 52. In the fixing device 50 incorporating the driver 55 that drives and rotates the fixing belt 51 instead of the pressure roller 52, the first nip formation pad 53 for forming the fixing nip N is also used as a component disposed opposite the driver 55 to sandwich the fixing belt 51 together with the driver 55, reducing the number of components incorporated in the fixing device 50 and simplifying the fixing device 50. The pressure roller 52 pressed against the fixing belt 51 at the fixing nip N is rotated clockwise in FIG. 2 in a rotation direction R3 in accordance with rotation of the fixing belt 51 in the rotation direction R2 by friction therebetween.

As shown in FIGS. 2 and 4, as the fixing belt 51 and the pressure roller 52 rotate in the rotation directions R2 and R3, respectively, a recording medium S (e.g., a sheet) entering the fixing device 50 is conveyed through the fixing nip N formed between the fixing belt 51 and the pressure roller 52 in a recording medium conveyance direction DS while the recording medium S contacts a recording medium conveyance span W spanning in the axial direction AD of the fixing belt 51. The recording medium S bears an unfixed toner image on a side of the recording medium S facing the fixing belt 51 or the pressure roller 52. The fixing belt 51 and the pressure roller 52 apply heat and pressure to the recording medium S bearing the toner image as the recording medium S is conveyed through the fixing nip N, thus fixing the toner image on the recording medium S.

The fixing device 50 includes a heater that heats the recording medium S bearing the toner image through at least one of the fixing belt 51 and the pressure roller 52. For example, the heater is a radiation heater, an electromagnetic induction heating coil, a resistance heat generator, or the like. The radiation heater includes a halogen heater disposed inside the loop formed by the fixing belt 51, thus irradiating the inner circumferential surface of the fixing belt 51 with light. Alternatively, the heater may be disposed outside the loop formed by the fixing belt 51 to heat the outer circumferential surface of the fixing belt 51. The heater heats the toner image on the recording medium S through at least one of the fixing belt 51 and the pressure roller 52, heating the toner image on the recording medium S effectively and stably.

A detailed description is now given of a construction of the fixing belt 51.

Considering the thermal capacity of the fixing belt 51 and a space inside the loop formed by the fixing belt 51 that accommodates various components, the fixing belt 51 is flexible and has a diameter in a range of from about 15 mm to about 300 mm. The fixing belt 51 is constructed of a base layer, an elastic layer, and a surface layer layered in this order from the inner circumferential surface to the outer circumferential surface of the fixing belt 51. The base layer is made of metal such as stainless steel, aluminum, and nickel to enhance the rigidity of the fixing belt 51. Alternatively, the base layer may be made of heat resistant resin such as polyimide. The elastic layer is made of an elastic material such as silicone rubber. Even if the recording medium S has surface asperities, the elastic layer elastically deforms to even pressure and heat transmitted and conducted from the fixing belt 51 and the pressure roller 52 to the recording medium S at the fixing nip N, improving the quality of the toner image fixed on the recording medium S. The surface layer is made of a material that facilitates separation of the recording medium S and toner of the toner image on the recording medium S from the fixing belt 51. For example, the surface layer is made of tetrafluoroethylene-perfluoroalkylvinylether copolymer (PFA), polytetrafluoroethylene (PTFE), polyimide (PI), polyether imide (PEI), polyether sulfide (PES), or the like.

If improvement in fixing quality is not requested substantially, the fixing belt 51 may have a bilayer constructed of the base layer and the surface layer, not incorporating the elastic layer. If the electromagnetic induction heating coil is used as the heater, the fixing belt 51 may further include a heat generation layer that generates heat by a magnetic flux from the electromagnetic induction heating coil. The heat generation layer is made of metal such as copper.

A detailed description is now given of a construction of the pressure roller 52.

The pressure roller 52 is constructed of a cored bar 52a made of metal and an elastic layer 52b coating the cored bar 52a and made of an elastic material such as silicone rubber and silicone rubber foam. A thin surface layer made of fluoroplastic such as PFA and PTFE may coat the elastic layer 52b to facilitate separation of the recording medium S and toner of the toner image on the recording medium S from the pressure roller 52.

A description is provided of a configuration of the first nip formation pad 53.

A rigidity of an outer circumferential surface of the first nip formation pad 53 disposed opposite the fixing nip N is greater than a rigidity of the outer circumferential surface of the pressure roller 52 disposed opposite the fixing nip N. The fixing nip N is contoured along the first nip formation pad 53. For example, the substantially planar first nip formation pad 53 produces the substantially planar fixing nip N, preventing the recording medium S passing through the fixing nip N from being curled and preventing the recording medium S constructed of a plurality of layered sheets (e.g., an envelope) from being skewed.

The first nip formation pad 53 is made of heat resistant resin such as liquid crystal polymer (LCP), polyimide, and polyamide imide (PAI). Alternatively, the first nip formation pad 53 may be made of metal such as aluminum and stainless steel. A sheet having a decreased friction coefficient may be wound around the first nip formation pad 53 or a material having a decreased friction coefficient may coat a slide face of the first nip formation pad 53 over which the fixing belt 51 slides to decrease the resistance against sliding of the fixing belt 51 that slides over the first nip formation pad 53.

A detailed description is now given of a configuration of the first support 54.

The first support 54 is made of rigid metal such as stainless steel and iron. The first support 54 has a rigidity great enough to retain a desired shape of the first nip formation pad 53 against pressure or reaction from the pressure roller 52 at the fixing nip N.

A detailed description is now given of a construction of the driver 55.

The driver 55 (e.g., a roller) is constructed of a cored bar 55a made of metal and an elastic layer 55b coating or mounted on the cored bar 55a and made of an elastic material such as rubber. The driver 55 is disposed downstream from the fixing nip N in the rotation direction R2 of the fixing belt 51 and in contact with the fixing belt 51.

A detailed description is now given of a configuration of lateral end flanges 56 and 57.

As shown in FIGS. 3 and 4, the lateral end flanges 56 and 57 are disposed at both lateral ends of the fixing belt 51 in the axial direction AD thereof, respectively. The lateral end flange 56 includes a belt support 56a and a belt stopper 56b. Similarly, the lateral end flange 57 includes a belt support 57a and a belt stopper 57b. The belt supports 56a and 57a are disposed opposite the inner circumferential surface of the fixing belt 51 to loosely support the inner circumferential surface of the fixing belt 51. The shape of each of the belt supports 56a and 57a and the rigidity of the fixing belt 51 are balanced to retain the shape of the fixing belt 51. The belt stoppers 56b and 57b are disposed opposite both lateral edge faces of the fixing belt 51, respectively. If the fixing belt 51 is skewed in the axial direction AD thereof toward one of the belt stoppers 56b and 57b in accordance with rotation of the fixing belt 51, the lateral edge face of the fixing belt 51 comes into contact with the one of the belt stoppers 56b and 57b. Thus, the one of the belt stoppers 56b and 57b restricts motion of the fixing belt 51 in the axial direction AD thereof.

A detailed description is now given of a configuration of two pairs of frames incorporated in the fixing device 50.

As shown in FIG. 4, the lateral end flanges 56 and 57 are mounted on a pair of frames 71 and 73 situated at both lateral ends of the fixing device 50 in the axial direction AD of the fixing belt 51, respectively. The first support 54 bridging the lateral end flanges 56 and 57 is mounted on and supported by the lateral end flanges 56 and 57. The cored bar 52a of the pressure roller 52 bridges another pair of frames 72 and 74 situated at both lateral ends of the fixing device 50 in the axial direction AD of the fixing belt 51, respectively. Thus, the pressure roller 52 is rotatably mounted on and supported by the frames 72 and 74 through bearings or the like, respectively.

A detailed description is now given of a configuration of a driving gear 81 incorporated in the fixing device 50.

The driving gear 81 is mounted on one end of the cored bar 55a of the driver 55 in the axial direction AD of the fixing belt 51. As a driver located outside the fixing device 50 drives the driving gear 81, the driver 55 mounting the driving gear 81 rotates. A driving torque of the driver 55 is transmitted to the fixing belt 51 and the pressure roller 52, rotating the fixing belt 51 and the pressure roller 52. The frames 71 and 73 may be moved relative to the frames 72 and 74, respectively, to separate the fixing belt 51 from the pressure roller 52.

A description is provided of configurations of a comparative fixing device.

The comparative fixing device produces a fixing nip formed between a fixing rotator and an opposed rotator pressed against the fixing rotator, through which a recording medium bearing a toner image is conveyed. The fixing nip is requested to have an increased length in a recording medium conveyance direction to allow the fixing rotator and the opposed rotator to apply heat and pressure to toner of the toner image on the recording medium sufficiently. Further, the fixing nip is requested to be substantially planar to prevent the recording medium passing through the fixing nip from being curled and prevent the recording medium constructed of a plurality of layered sheets (e.g., an envelope) from being skewed. Hence, the fixing rotator is requested to have a decreased curvature at the fixing nip. Conversely, the fixing rotator is requested to have an increased curvature at a position in proximity to an exit of the fixing nip to facilitate separation of the recording medium ejected from the fixing nip from the fixing rotator.

If each of the fixing rotator and the opposed rotator is an endless belt, it is easier to change the curvature of the endless belt at a plurality of positions on the endless belt compared to a construction in which at least one of the fixing rotator and the opposed rotator is a roller. Alternatively, the comparative fixing device may include a nip formation pad that contacts and supports an inner circumferential surface of the endless belt serving as the fixing rotator to produce the substantially planar fixing nip.

However, when the endless belt slides over the nip formation pad, the resistance against rotation of the endless belt may increase the driving torque of the endless belt. If the fixing rotator is an endless belt and the opposed rotator is a roller pressed against the nip formation pad via the endless belt, the roller may drive and rotate the endless belt at the fixing nip. However, the roller may be exerted with an increased driving torque and therefore is susceptible to damage or breakage. If the roller is made of an elastic body having a decreased rigidity to increase the length of the fixing nip in the recording medium conveyance direction, the roller is more susceptible to damage or breakage.

Alternatively, if the fixing rotator is a first endless belt and the opposed rotator is a second endless belt, a first belt driver may contact an inner circumferential surface of the first endless belt and a second belt driver may contact an inner circumferential surface of the second endless belt. The first belt driver and the second belt driver sandwich the first endless belt to drive and rotate the first endless belt. However, the pair of the first belt driver and the second belt driver is needed in addition to the nip formation pad to drive the first endless belt, increasing the number of components incorporated in the comparative fixing device and complicating the comparative fixing device.

A description is provided of advantages of the fixing device 50 depicted in FIGS. 2 to 4 over the comparative fixing device.

The pressure roller 52 does not drive and rotate the fixing belt 51. That is, the pressure roller 52 rotates in accordance with rotation of the fixing belt 51 driven and rotated by the driver 55. Accordingly, since the pressure roller 52 is driven and rotated by the fixing belt 51, the pressure roller 52 is exerted with a decreased driving torque and therefore is immune from damage and breakage. As shown in FIG. 2, the elastic layer 52b of the pressure roller 52 that produces the fixing nip N is made of an elastic body having a decreased rigidity. Hence, the elastic layer 52b increases a length of the fixing nip N in the recording medium conveyance direction DS without increasing the driving torque of the pressure roller 52.

A recording medium separation span F of the fixing belt 51 where the recording medium S is separated from the fixing belt 51 is defined between an exit of the fixing nip N and the driver 55 in the rotation direction R2 of the fixing belt 51. The recording medium separation span F of the fixing belt 51 receives a driving force generated by the driver 55 and a resistance of the fixing nip N against sliding of the fixing belt 51 over the first nip formation pad 53 at both ends of the recording medium separation span F in a circumferential direction of the fixing belt 51. Hence, the recording medium separation span F of the fixing belt 51 receives a tension that stretches the fixing belt 51. Simultaneously, the shape of the first nip formation pad 53 is adjusted to create a belt stretch portion D over which the fixing belt 51 rotating in the rotation direction R2 is stretched taut. Thus, the fixing belt 51 has a shape contoured along the first nip formation pad 53.

According to this example embodiment, the first nip formation pad 53 is substantially L-shaped in cross-section. The belt stretch portion D of the first nip formation pad 53 is a substantially L-shaped curved portion contacting a part of the recording medium separation span F of the fixing belt 51 where the fixing belt 51 is stretched taut over the first nip formation pad 53. The fixing belt 51 rotating in the rotation direction R2 slides over the belt stretch portion D of the first nip formation pad 53 along a curve of the first nip formation pad 53, suppressing change in the curvature of the fixing belt 51 in the recording medium separation span F thereof that contacts the belt stretch portion D of the first nip formation pad 53 and therefore facilitating separation of the recording medium S from the fixing belt 51.

According to this example embodiment, the belt stretch portion D of the first nip formation pad 53 extends throughout the recording medium separation span F of the fixing belt 51 in the circumferential direction of the fixing belt 51. Alternatively, the belt stretch portion D may be smaller than the recording medium separation span F. Yet alternatively, a part of the recording medium separation span F of the fixing belt 51 that is disposed opposite the belt stretch portion D of the first nip formation pad 53 may have a decreased radius of curvature compared to other part of the recording medium separation span F of the fixing belt 51. Since the part of the fixing belt 51 that has the decreased radius of curvature is situated at a particular position in the recording medium separation span F of the fixing belt 51, the belt stretch portion D separates the recording medium S conveyed over the recording medium separation span F of the fixing belt 51 from the fixing belt 51 precisely. An upstream portion E of the first nip formation pad 53 facing the fixing nip N and disposed upstream from the belt stretch portion D in the rotation direction R2 of the fixing belt 51 is substantially platy. Conversely, the belt stretch portion D has the decreased radius of curvature to form a sharp curve or an increased curve. Accordingly, the fixing belt 51 stretched taut over the first nip formation pad 53 is curved along the curve of the first nip formation pad 53, allowing the belt stretch portion D to facilitate separation of the recording medium S from the fixing belt 51.

With reference to FIGS. 5 to 9, a description is provided of a construction of a fixing device 50S according to a second example embodiment.

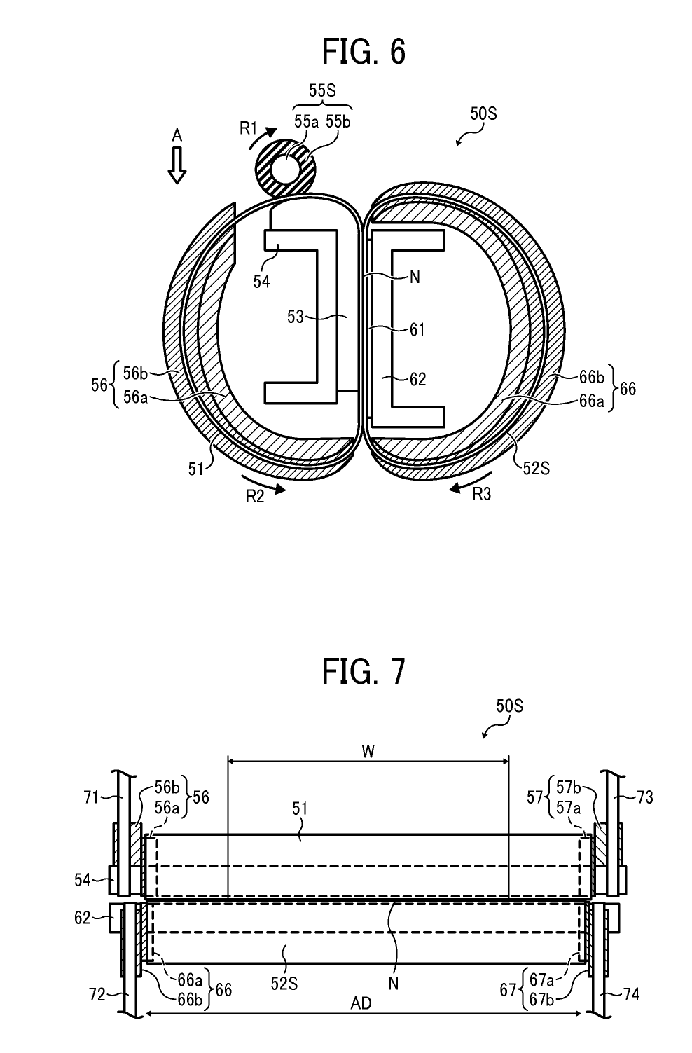

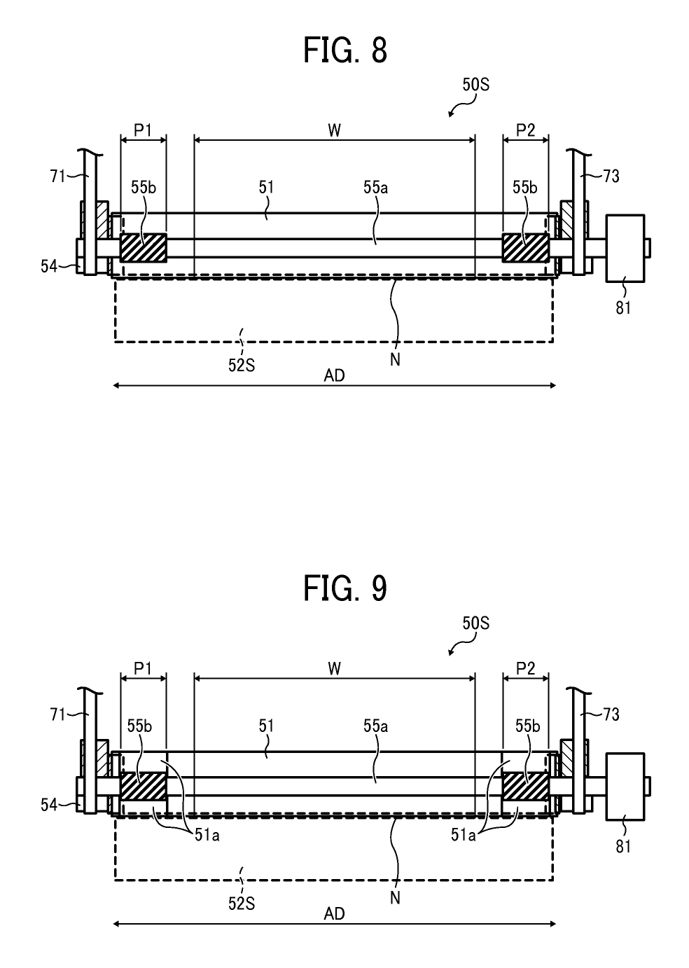

FIG. 5 is a schematic vertical sectional view of the fixing device 50S at a center thereof. FIG. 6 is a schematic vertical sectional view of the fixing device 50S at a lateral end thereof. FIG. 7 is a schematic horizontal sectional view of the fixing device 50S seen from the direction A in FIGS. 5 and 6 as the axial direction AD of the fixing belt 51 defines the horizontal direction. FIG. 8 is a partial horizontal sectional view of the fixing device 50S. FIG. 9 is another partial horizontal sectional view of the fixing device 505. FIGS. 5 to 9 do not illustrate components of the fixing device 505 equivalent to those of the fixing device 50 depicted in FIGS. 2 to 4 entirely or partially. For example, FIG. 7 does not illustrate the driver 55 and its peripherals. FIGS. 8 and 9 illustrate a pressure belt 52S in the dotted line and do not illustrate its peripherals. The components of the fixing device 505 equivalent to those of the fixing device 50 depicted in FIGS. 2 to 4 structurally and functionally are assigned with the identical reference numerals.

Like the pressure roller 52 of the fixing device 50 depicted in FIG. 2, the pressure belt 52S serving as an opposed rotator, a second rotator, or an endless belt does not drive and rotate the fixing belt 51. Instead, a driver 55S contacting the outer circumferential surface of the fixing belt 51 drives and rotates the fixing belt 51 as shown in FIG. 6. As the driver 55S rotates clockwise in FIG. 6 in the rotation direction R1 while the driver 55S and the first nip formation pad 53 sandwich the fixing belt 51, the driver 55S drives and rotates the fixing belt 51 counterclockwise in FIG. 6 in the rotation direction R2. The pressure belt 52S pressed against the fixing belt 51 at the fixing nip N is rotated clockwise in FIG. 6 in the rotation direction R3 in accordance with rotation of the fixing belt 51 in the rotation direction R2 by friction therebetween. The following describes a construction of the fixing device 505 according to the second example embodiment that is different from the construction of the fixing device 50 according to the first example embodiment.

The fixing device 505 according to the second example embodiment is different from the fixing device 50 according to the first example embodiment in that the fixing device 505 includes the pressure belt 52S, that is, a thin endless belt, serving as an opposed rotator. Inside a loop formed by the pressure belt 52S are a second nip formation pad 61 over which the pressure belt 52S slides and a second support 62 contacting and supporting the second nip formation pad 61. The second nip formation pad 61 contacts an inner circumferential surface of the pressure belt 52S to support the pressure belt 52S, forming the fixing nip N between the fixing belt 51 and the pressure belt 52S. The second support 62 contacts and supports the second nip formation pad 61 to suppress deformation of the second nip formation pad 61 that may appear as the second nip formation pad 61 receives pressure or reaction from the fixing nip N.

As shown in FIG. 7, lateral end flanges 66 and 67 are mounted on the frames 72 and 74 situated at both lateral ends of the fixing device 50S in the axial direction AD of the fixing belt 51, respectively. The lateral end flanges 66 and 67 are situated at both lateral ends of the pressure belt 52S in an axial direction thereof, respectively. The second support 62 bridging the lateral end flanges 66 and 67 is mounted on and supported by the lateral end flanges 66 and 67. The lateral end flange 66 includes a belt support 66a and a belt stopper 66b. Similarly, the lateral end flange 67 includes a belt support 67a and a belt stopper 67b. The belt supports 66a and 67a and the belt stoppers 66b and 67b are equivalent to the belt supports 56a and 57a and the belt stoppers 56b and 57b depicted in FIG. 4 structurally and functionally.

The configuration and the material of the pressure belt 52S, the second nip formation pad 61, the second support 62, and the like are equivalent to those of the pressure roller 52, the first nip formation pad 53, the first support 54, and the like depicted in FIG. 2. However, as shown in FIGS. 5 and 6, the second nip formation pad 61 is not L-shaped in cross-section. For example, the pressure belt 52S does not receive a tension that stretches the pressure belt 52S at a position downstream from the fixing nip N in the rotation direction R3 of the pressure belt 52S. Hence, even if the second nip formation pad 61 includes an L-shaped curve, the pressure belt 52S is not stretched taut over the L-shaped curve of the second nip formation pad 61. However, even if the pressure belt 52S is not stretched taut over the second nip formation pad 61, the circumferential length and the rigidity of the pressure belt 52S in a circumferential direction thereof are adjusted to attain a desired curvature of the pressure belt 52S at the position downstream from the fixing nip N in the rotation direction R3 of the pressure belt 52S, facilitating separation of the recording medium S from the pressure belt 52S.

As shown in FIGS. 5 and 6, according to this example embodiment, a pair of nip formation pads, that is, the first nip formation pad 53 and the second nip formation pad 61, and a pair of belts, that is, the fixing belt 51 and the pressure belt 52S sliding over the first nip formation pad 53 and the second nip formation pad 61, respectively, form the fixing nip N increased in the recording medium conveyance direction DS. Additionally, the pressure belt 52S has a decreased thermal capacity that reduces energy consumption of the fixing device 505.

As shown in FIGS. 6 and 8, the fixing device 505 is different from the fixing device 50 in that the driver 55S contacts the fixing belt 51 partially in the axial direction AD of the fixing belt 51. As shown in FIG. 8, the elastic layer 55b of the driver 55S that contacts the fixing belt 51 is disposed at each lateral end of the fixing belt 51 in the axial direction AD thereof. The elastic layers 55b of the driver 55S contact driving spans P1 and P2 of the fixing belt 51 not overlapping the recording medium conveyance span W in the axial direction AD of the fixing belt 51 to drive and rotate the fixing belt 51 frictionally. That is, the fixing belt 51 has the driving spans P1 and P2 contacted by the driver 55S and the recording medium conveyance span W where the recording medium S is conveyed. The driving spans P1 and P2 are outboard from the recording medium conveyance span W in the axial direction AD of the fixing belt 51.

Since the driving spans P1 and P2 are disposed outboard from the recording medium conveyance span W in the axial direction AD of the fixing belt 51, the recording medium conveyance span W on the outer circumferential surface of the fixing belt 51 where the recording medium S and the unfixed toner image on the recording medium S contact the fixing belt 51 is not contacted by the driver 55S, thus being immune from damage or abrasion that may result in degradation in fixing quality. Additionally, even if a slight amount of a foreign substance (e.g., toner particles and paper dust) is adhered to the fixing belt 51 from the recording medium S passing through the fixing nip N, the driver 55S disposed outboard from the recording medium conveyance span W in the axial direction AD of the fixing belt 51 is not stained with the foreign substance and therefore is immune from degradation in surface condition.

Alternatively, the fixing belt 51 may include a friction resistance layer 51a constituting the outer circumferential surface of the fixing belt 51 at least in the driving spans P1 and P2 thereof that contact the driver 55S as shown in FIG. 9. FIG. 9 illustrates the friction resistance layer 51a of the fixing belt 51. As shown in FIG. 9, the friction resistance layer 51a spans each of the driving spans P1 and P2 of the fixing belt 51 and increases the maximum static friction against the driver 55S. Accordingly, even if the area defined by the driving spans P1 and P2 is smaller than the area defined by the fixing nip N, a driving torque is transmitted from the driver 55S to the fixing belt 51 precisely. Alternatively, the friction resistance layer 51a may span beyond the driving spans P1 and P2 in the axial direction AD of the fixing belt 51. Yet alternatively, the friction resistance layer 51a may span the recording medium conveyance span W if it does not degrade separation of the recording medium S and toner of the toner image on the recording medium S from the fixing belt 51. Yet alternatively, instead of or in addition to the driving spans P1 and P2, the friction resistance layer 51a may coat the elastic layer 55b of the driver 55S. Yet alternatively, the elastic layer 55b of the driver 55S may have an increased surface roughness.

Additionally, the driving spans P1 and P2 where the elastic layers 55b of the driver 55S contact the fixing belt 51 are disposed at both lateral ends of the fixing belt 51 that are outboard from the recording medium conveyance span W in the axial direction AD of the fixing belt 51, respectively, thus rotating the fixing belt 51 stably.

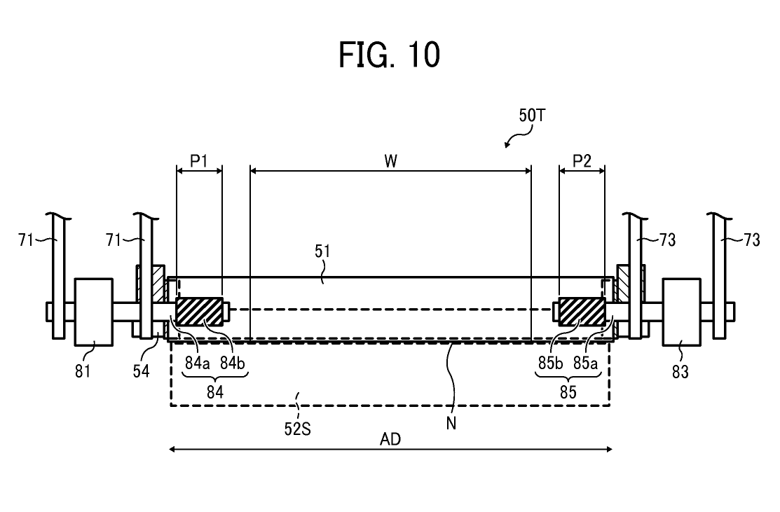

With reference to FIG. 10, a description is provided of a construction of a fixing device 50T according to a third example embodiment.

FIG. 10 is a partial horizontal sectional view of the fixing device 50T. FIG. 10 illustrates the pressure belt 52S in the dotted line and does not illustrate its peripherals. Like the pressure roller 52 of the fixing device 50 depicted in FIG. 2, the pressure belt 52S serving as an opposed rotator, a second rotator, or an endless belt does not drive and rotate the fixing belt 51. Instead, drivers 84 and 85 contacting the outer circumferential surface of the fixing belt 51 drive and rotate the fixing belt 51. As the drivers 84 and 85 rotate while the drivers 84 and 85 and the first nip formation pad 53 depicted in FIG. 6 sandwich the fixing belt 51, the drivers 84 and 85 drive and rotate the fixing belt 51 in the rotation direction R2. The pressure belt 52S pressed against the fixing belt 51 at the fixing nip N is rotated in the rotation direction R3 in accordance with rotation of the fixing belt 51 in the rotation direction R2 by friction therebetween.

A description is provided of a construction of the fixing device 50T according to the third example embodiment that is different from the construction of the fixing device 50 according to the first example embodiment or the fixing device 50S according to the second example embodiment.

As shown in FIG. 10, the fixing belt 51 has the driving span P1 serving as a first driving span and the driving span P2 serving as a second driving span that are disposed outboard from the recording medium conveyance span W in the axial direction AD of the fixing belt 51. The drivers 84 and 85 do not span throughout the entire span of the fixing belt 51 in the axial direction AD thereof. The driver 84 serving as a first driver contacts the driving span P1 of the fixing belt 51 to drive and rotate the fixing belt 51. The driver 85 serving as a second driver contacts the driving span P2 of the fixing belt 51 to drive and rotate the fixing belt 51. The driver 84 includes a cored bar 84a and an elastic layer 84b. The driver 85 includes a cored bar 85a and an elastic layer 85b. The elastic layers 84b and 85b contact the outer circumferential surface of the fixing belt 51 in the driving spans P1 and P2, respectively. Additionally, the drivers 84 and 85 drive and rotate the fixing belt 51 in the driving spans P1 and P2 where the fixing belt 51 sliding over the first nip formation pad 53 is exerted with an increased resistance, thus rotating the fixing belt 51 stably.

Separate driving gears 81 and 83 are connected to the drivers 84 and 85 to drive the drivers 84 and 85, respectively, which in turn drive and rotate the fixing belt 51. The driving gear 83 is actuated separately from the driving gear 81 to drive the driver 85 independently from the driver 84. Two pairs of frames 71 and 73 situated at both lateral ends of the fixing device 50T contact and support the drivers 84 and 85, respectively. The driving gear 81 is interposed between the pair of frames 71. Similarly, the driving gear 83 is interposed between the pair of frames 73. When a driving source (e.g., a motor) located outside the fixing device 50T actuates the driving gears 81 and 83, the driving source adjusts the rotation speed of each of the driving gears 81 and 83 separately. Accordingly, even if an outer diameter of the driver 84 is different from an outer diameter of the driver 85, for example, the drivers 84 and 85 drive and rotate the fixing belt 51 in the driving spans P1 and P2, respectively, at an identical rotation speed. Additionally, the drivers 84 and 85 prevent variation in the rotation speed of the fixing belt 51 between both lateral ends of the fixing belt 51 outboard from the recording medium conveyance span W in the axial direction AD of the fixing belt 51, suppressing inclination of a rotation shaft of the fixing belt 51 and the pressure belt 52S.

If the drivers 84 and 85 start and stop their rotation at substantially different times, respectively, the fixing belt 51 and the pressure belt 52S may be twisted. To address this circumstance, like the fixing device 505 according to the second example embodiment shown in FIG. 8, the single driving gear 81 connected to the driver 55S to actuate the driver 55S may be employed. In this case, the single driving gear 81 is connected to a first driver constructed of the cored bar 55a and the elastic layer 55b contacting the driving span P1 and a second driver constructed of the cored bar 55a and the elastic layer 55b contacting the driving span P2 to drive and rotate the first driver and the second driver. Accordingly, the simple single driver (e.g., the driver 55S) drives and rotates the fixing belt 51 by starting and stopping rotation concurrently at both lateral ends of the fixing belt 51 outboard from the recording medium conveyance span W in the axial direction AD of the fixing belt 51, thus preventing twisting of the fixing belt 51 and the pressure belt 52S.

A description is provided of advantages of the fixing devices 50, 505, and 50T.

As shown in FIGS. 2, 6, and 10, a fixing device (e.g., the fixing devices 50, 50S, and 50T) includes a fixing belt (e.g., the fixing belt 51) rotatable in a given direction of rotation and an opposed rotator (e.g., the pressure roller 52 and the pressure belt 52S) disposed opposite the fixing belt. An outer circumferential surface of the opposed rotator is pressed against an outer circumferential surface of the fixing belt to form the fixing nip N therebetween. A first nip formation pad (e.g., the first nip formation pad 53) contacts and supports an inner circumferential surface of the fixing belt to form the fixing nip N such that the inner circumferential surface of the fixing belt slides over the first nip formation pad. A driver (e.g., the drivers 55, 55S, 84, and 85) contacts the outer circumferential surface of the fixing belt to drive and rotate the fixing belt. As a recording medium S is conveyed through the fixing nip N, the fixing belt and the opposed rotator fix a toner image on the recording medium S under heat and pressure. The opposed rotator is rotated frictionally by the fixing belt at the fixing nip. The driver sandwiches the fixing belt together with the first nip formation pad. The driver rotates to drive and rotate the fixing belt.

Accordingly, the driver decreases a driving torque exerted to the opposed rotator, suppressing damage and breakage of the opposed rotator, even if the opposed rotator is made of an elastic body having a decreased rigidity, and therefore attaining an extended life of the opposed rotator. In the fixing device incorporating the driver that drives and rotates the fixing belt instead of the opposed rotator, the first nip formation pad for forming the fixing nip N is also used as a component disposed opposite the driver to sandwich the fixing belt together with the driver, reducing the number of components incorporated in the fixing device and simplifying the fixing device.

According to the example embodiments described above, the fixing belt 51 serves as a fixing belt. Alternatively, a fixing film, a fixing sleeve, or the like may be used as a fixing belt.

The present disclosure has been described above with reference to specific example embodiments. Note that the present disclosure is not limited to the details of the embodiments described above, but various modifications and enhancements are possible without departing from the spirit and scope of the disclosure. It is therefore to be understood that the present disclosure may be practiced otherwise than as specifically described herein. For example, elements and/or features of different illustrative example embodiments may be combined with each other and/or substituted for each other within the scope of the present disclosure.

What is claimed is:

1. A fixing device comprising:
an endless fixing belt rotatable in a given direction of rotation;
a first nip formation pad contacting an inner circumferential surface of the fixing belt;
a first driver sandwiching the fixing belt together with the first nip formation pad, the first driver to rotate to drive and rotate the fixing belt; and
an opposed rotator pressed against the first nip formation pad via the fixing belt to form a fixing nip between the fixing belt and the opposed rotator, through which a recording medium is conveyed, the opposed rotator to be rotated frictionally by the fixing belt at the fixing nip.

2. The fixing device according to claim 1, wherein the first nip formation pad includes a belt stretch portion disposed downstream from the fixing nip in the direction of rotation of the fixing belt and disposed opposite the first driver, the belt stretch portion over which the fixing belt is stretched taut.

3. The fixing device according to claim 2, wherein the belt stretch portion of the first nip formation pad contacts a recording medium separation span of the fixing belt that separates the recording medium from the fixing belt.

4. The fixing device according to claim 3, wherein the belt stretch portion of the first nip formation pad is curved to contour the fixing belt to have a decreased radius of curvature.

5. The fixing device according to claim 3, wherein the recording medium separation span of the fixing belt is defined between an exit of the fixing nip and the first driver in the direction of rotation of the fixing belt.

6. The fixing device according to claim 2, wherein the first nip formation pad further includes a substantially platy, upstream portion disposed upstream from the belt stretch portion in the direction of rotation of the fixing belt.

7. The fixing device according to claim 1, further comprising a second nip formation pad contacting an inner circumferential surface of the opposed rotator to form the fixing nip,
wherein the opposed rotator includes an endless belt.

8. The fixing device according to claim 1, wherein the fixing belt includes a friction resistance layer contacting the first driver and defining a first driving span spanning in an axial direction of the fixing belt where the first driver contacts the fixing belt, the friction resistance layer to increase a static friction against the first driver.

9. The fixing device according to claim 1, wherein the fixing belt includes:
a recording medium conveyance span spanning in an axial direction of the fixing belt where the recording medium is conveyed and the first driver does not contact the fixing belt; and
a first driving span disposed outboard from the recording medium conveyance span in the axial direction of the fixing belt where the first driver contacts the fixing belt.

10. The fixing device according to claim 9, wherein the first driving span is disposed at one lateral end of the fixing belt in the axial direction thereof.

11. The fixing device according to claim 10, further comprising a second driver sandwiching the fixing belt together with the first nip formation pad, the second driver to rotate to drive and rotate the fixing belt,
wherein the second driver contacts a second driving span of the fixing belt that is disposed outboard from the recording medium conveyance span in the axial direction of the fixing belt and disposed at another lateral end of the fixing belt in the axial direction thereof.

12. The fixing device according to claim 11, further comprising a first driving gear connected to the first driver and the second driver to drive and rotate the first driver and the second driver.

13. The fixing device according to claim 11, further comprising:
a first driving gear connected to the first driver to drive and rotate the first driver; and
a second driving gear connected to the second driver to drive and rotate the second driver, the second driving gear being actuated separately from the first driving gear.

14. The fixing device according to claim 11, wherein each of the first driver and the second driver includes a roller including:
a cored bar disposed at each lateral end of the fixing belt disposed outboard from the recording medium conveyance span in the axial direction thereof; and
an elastic layer mounted on the cored bar and contacting the fixing belt.

15. The fixing device according to claim 1, wherein the first driver includes a roller including:
a cored bar extending throughout an entire span of the fixing belt in an axial direction thereof; and
an elastic layer mounted on the cored bar and contacting the fixing belt.

16. The fixing device according to claim 15, wherein the elastic layer extends throughout substantially the entire span of the fixing belt in the axial direction thereof.

17. The fixing device according to claim 15, wherein the elastic layer is disposed at each lateral end of the fixing belt disposed outboard from a recording medium conveyance span spanning in the axial direction of the fixing belt where the recording medium is conveyed.

18. The fixing device according to claim 1, wherein the opposed rotator includes a pressure roller made of an elastic body.

19. An image forming apparatus comprising:
an image forming device to form a toner image; and
a fixing device, disposed downstream from the image forming device in a recording medium conveyance direction, to fix the toner image on a recording medium,
the fixing device including:
an endless fixing belt rotatable in a given direction of rotation;
a first nip formation pad contacting an inner circumferential surface of the fixing belt;
a first driver sandwiching the fixing belt together with the first nip formation pad, the first driver to rotate to drive and rotate the fixing belt; and
an opposed rotator pressed against the first nip formation pad via the fixing belt to form a fixing nip between the fixing belt and the opposed rotator, through which the recording medium is conveyed, the opposed rotator to be rotated frictionally by the fixing belt at the fixing nip.
